(19) United States
(12) Patent Application Publication
(10) Pub. No.: US 2004/0026820 A1
(43) Pub. Date: Feb. 12, 2004

(54) Process for manufacturing a sole for shoes composed of a tread sole made of vulcanized rubber mated with a poluurethane mid-sole

(76) Inventor: Lorenzo Lorenzin, Abano Terme (IT)

Correspondence Address: Modiano & Association, Via Meravigli 16, Milano 20123, IT

(21) Appl. No.: 10/450,567

(22) PCT Filed: Dec. 21, 2001
(86) PCT No.: PCT/EP01/15284

(30) Foreign Application Priority Data
Dec. 28, 2000 (IT) PD00A00295

(51) Int. Cl. B29C 31/00

(52) U.S. Cl. 264/240; 264/255; 425/119

(57) ABSTRACT

A process for manufacturing a sole for shoes composed of a tread sole made of vulcanised rubber provides, for the vulcanizable rubber, a mixture composed of a vulcanizable nitrile rubber (NBR), at least one hydroxyl acrylic resin, at least one hydrocarbon resin, at least one reinforcing filler, and at least one vulcanization accelerator. A dosed amount of the mixture is introduced in a first mold cavity (2), in which the bottom is constituted by a piston (12), which is kept at a temperature of 100-200 ° C., while in an upper region there is a dummy last (8), which is also kept at a temperature of 100-200 ° C., the two temperatures being adjustable independently of each other. After preparing the tread sole in this manner, the sole bottom, supported by the piston, descends and forms an additional cavity into which the two-component polyurethane is injected. The vulcanizable rubber with the mixture adopted has many free bonds, which combine with the polyurethane, giving rise to a very strong coupling.

### BACKGROUND OF THE INVENTION

The present invention relates to a process for manufacturing a sole for shoes composed of a tread sole made of vulcanized rubber mated with a polyurethane mid-sole.

The present invention also relates to the use of a particular mixture for the vulcanizable rubber, which is suitable to mate very firmly to the polyurethane, and to the means for performing the process.

The problems encountered in coupling vulcanized rubber and polyurethane are known from the background art.

The two materials, at least the ones used up to now, are substantially mutually incompatible and in order to associate them the vulcanized rubber must be cold-treated with a primer that makes it ready to receive the poured or injected polyurethane.

This entails, in the production of shoe soles or of shoes, the need to provide tread soles made of vulcanized rubber with a prepared surface, which must then be placed in the molds into which the polyurethane will be injected or poured.

Instead of treatment with a primer, other solutions have been adopted which entail placing a felt between the vulcanized rubber and the polyurethane, and this felt must be compatible with both materials.

With these problems, it is evident that the vulcanized rubber tread sole cannot be prepared in the same production cycle as the sole or shoe but must be prepared beforehand and separately, allowed to cool, and then subjected to a surface treatment, or it is necessary to use an accessory component.

The production of shoes with a vulcanized rubber tread and a polyurethane mid-sole is therefore scarcely convenient and excessively expensive.

On the other hand, the advantages of a sole with a tread made of vulcanized rubber and the remaining part (mid-sole) made of polyurethane would be considerable, since a vulcanized rubber tread is highly resistant to wear and thermal abrasion and a polyurethane mid-sole is very light and comfortable.

### SUMMARY OF THE INVENTION

The aim of the present invention is to provide a process that allows to manufacture, in a same working cycle, a sole with a vulcanized rubber tread mated with a polyurethane mid-sole.

Within this aim, an object is to provide a process that does not require idle times between the preparation of the vulcanized rubber sole and its subsequent coupling to a polyurethane mid-sole formed within a mold.

Another object is to provide a process, and means for performing it, in which treatment of the vulcanized rubber sole is not required before injection or pouring into the polyurethane mold.

Another object is to provide products that can be suitable to perform the process.

This aim and these and other objects that will become better apparent hereinafter are achieved by a process for manufacturing a sole for shoes composed of a tread sole made of vulcanized rubber coupled to a polyurethane mid-sole, characterized in that:

a) for the vulcanizable rubber, a mixture is provided which is composed of:

a₁) a vulcanizable nitrile rubber (NBR)

a₂) at least one hydroxyl acrylic resin;

a₃) at least one hydrocarbon resin;

a₄) at least one reinforcing filler;

a₅) at least one vulcanization accelerator;

b) a dosed amount of said mixture is introduced in a first cavity of a mold, which is formed by a pseudocylindrical side wall within which a sole bottom piston can perform a translational motion and is closed in an upper region by a first replaceable dummy last;

c) the process waits for the duration of the vulcanization time, keeping the sole bottom piston at a temperature of 100-200 ° C. and the dummy last at a temperature of 100-200 ° C., allowing their adjustment independently of each other and so that the sole bottom temperature is never lower than the temperature of the dummy last;

d) the sole bottom, with the tread sole adhering thereto, is subjected to a translational motion, so as to generate a second cavity, and the dummy last is replaced with a second dummy last or with a last with a fitted upper, closing it with the rings;

e) a dosed quantity of two-component polyurethane is injected into said second cavity;

f) the process waits for the reaction time of the polyurethane, keeping the second dummy last or the rings at a temperature of 30-80 ° C.;

g) the sole is extracted and allowed to rest for the stabilization time.

The present invention also relates to a mold for performing the process, which has a bottom constituted by the head of a movable piston, said head having the shape and the impression of the tread sole to be obtained, a replaceable dummy last and means for the controlled heating of the bottom of the mold and of the dummy last.

The present invention also relates to the use of a mixture of vulcanizable rubber to perform the process, characterized in that it is composed of:

a₁) a vulcanizable nitrile rubber (NBR);

a₂) at least one hydroxyl acrylic resin;

a₃) at least one hydrocarbon resin;

a₄) at least one reinforcing filler;

a₅) at least one vulcanization accelerator.

### BRIEF DESCRIPTION OF THE DRAWINGS

Further characteristics and advantages of the invention will become better apparent from the following detailed description of a preferred embodiment of the process and of the means for performing it, also with the aid of the accompanying drawings, wherein:

FIG. 1 is a schematic sectional view of the mold used;

FIG. 2 is a more detailed view of the structure of the mold and of the means for moving it, with the mold shown in the open position;

FIG. 3 is a view of the assembly of FIG. 2, with the mold closed in order to form the vulcanized rubber tread sole;

FIG. 4 is a view of the mold and of its closure means during the step of the process related to the injection of the polyurethane.

### DESCRIPTION OF THE PREFERRED EMBODIMENTS

The process according to the invention provides for a first step, during which a vulcanizable rubber is prepared which is obtained with a mixture composed of:

a₁) a vulcanizable nitrile rubber (NBR);

a₂) at least one hydroxyl acrylic resin;

a₃) at least one hydrocarbon resin;

a₄) at least one reinforcing filler;

a₅) at least one vulcanization accelerator.

The nitrile rubber that is used is conveniently of the medium-high nitrile type with a low Mooney value (low viscosity).

A rubber of this type is a butadiene-acrylonitrile copolymer, technically designated by the acronym NBR.

The mixture contains a hydroxyl acrylic resin, i.e., a polyacrylic resin with an OH content of less than 2.

Such resin is preferably used in a solvent and its percentage by weight is between 4 and 6% of the total weight of the mixture.

The mixture also contains a hydrocarbon resin of the family of aliphatic resins of petrochemical origin.

The hydrocarbon resin, preferably in the solid state, is present in a percentage by weight of 3 to 5% of the total weight of the mixture.

The hydrocarbon resin is a combination of hydrocarbon chains of C₅ origin.

A reinforcing filler of the siliceous type is also added to the mixture.

The reinforcing filler is preferably precipitated amorphous silica or is a mixture containing 85 to 90% SiO₂ with a BET value between 150 and 200 m²/g.

The reinforcing filler is present in a percentage by weight between 20 and 25% of the total weight of the mixture.

The vulcanization accelerator is of the mercaptan class, with the addition of an ultra-accelerator of the thiuram class.

The accelerator is introduced in the mixture in a percentage by weight between 1 and 1.5% of the total weight of the mixture.

Before continuing with the description of the process, it is useful to describe the structure of the mold that is used; this is done with reference to the two accompanying drawings.

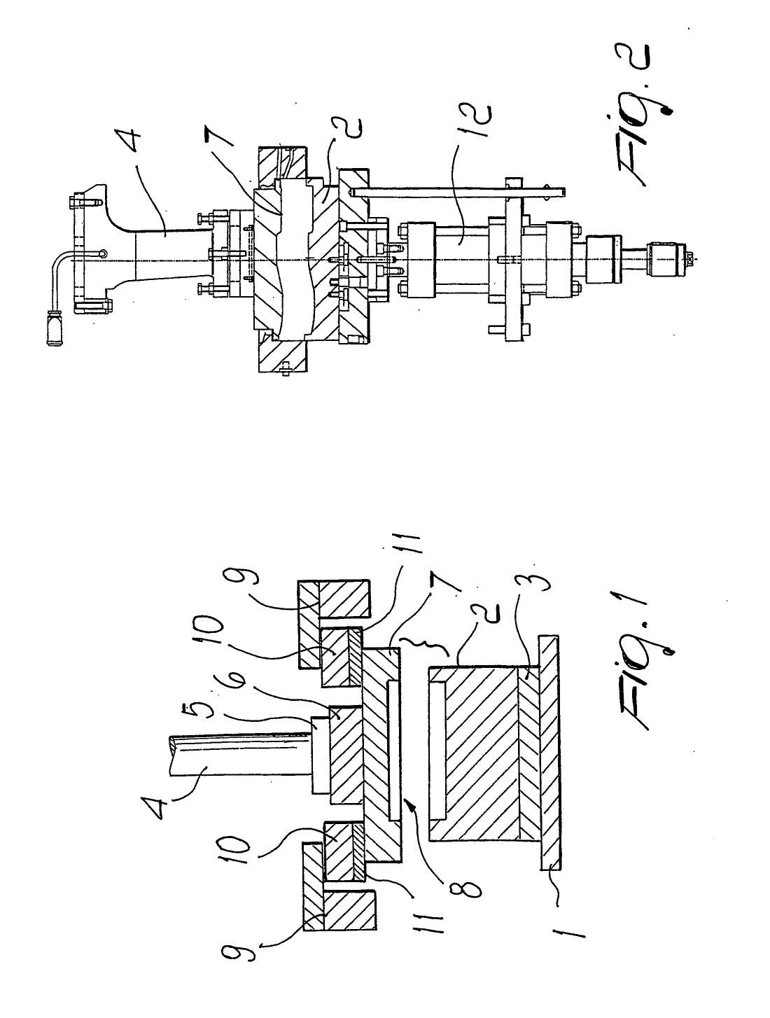

With reference to the drawings, FIG. 1 is a schematic view of the mold used in the process according to the invention.

The mold is composed of a carriage plate 1, on which the part of the mold 2 that will form the sole bottom of the vulcanized rubber sole is fixed.

The mold part 2 is fixed to the carriage plate 1, with a heating plate 3 interposed.

The arm 4 of a pivot coupling for the rotation of the last is visible in an upper region.

An insulating plate 5 is present in the lower part of said arm and supports, with a heating plate 6 interposed, a dummy last 7, which is provided with a cavity 8 that matches the upper part of the vulcanized rubber sole.

FIG. 1 again illustrates the ring holders 9 and the rings of the mold 10 that act on the dummy last 8 with insulation means 11 interposed.

The combination of the heating plates and of the insulating means allows to adjust independently the upper and lower temperatures of the mold.

FIGS. 2, 3 and 4 illustrate in greater detail the structure of the mold and of its fixtures.

FIG. 2 is a view of the assembly in the condition in which the mold is open, the mold being the one intended to manufacture the tread sole.

The figure clearly illustrates the presence of a piston 12, which allows to produce the translational motion of the lower part 2 of the mold.

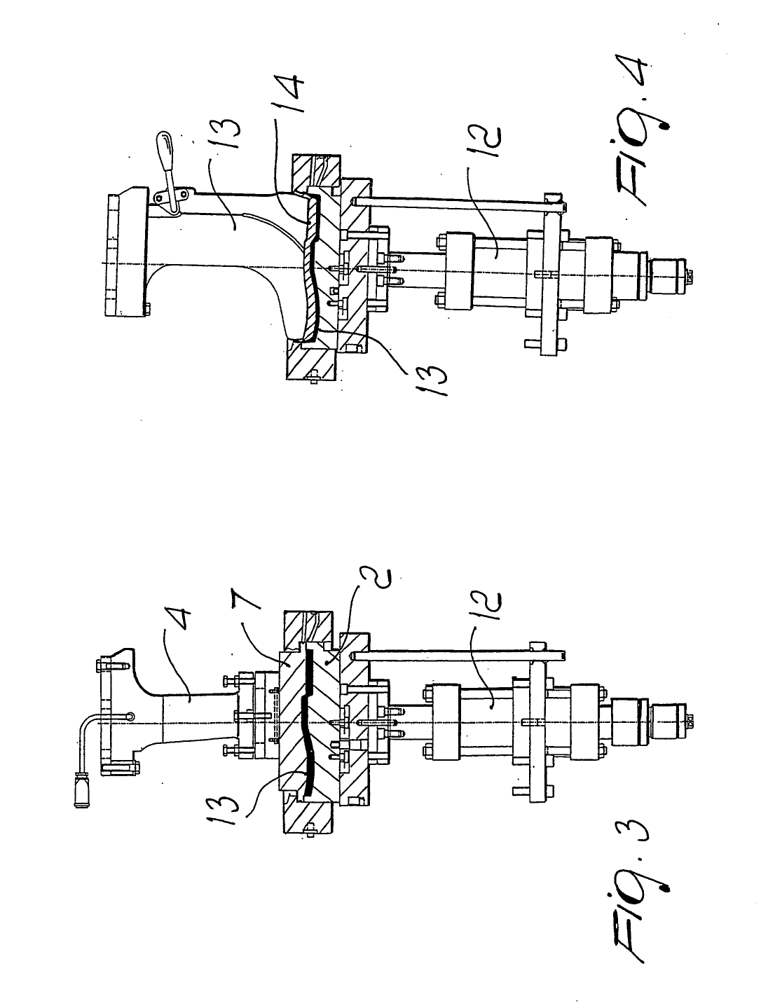

FIG. 3 illustrates the same assembly as FIG. 2, in the condition in which the mold is closed during the step in which the tread sole, designated by the reference numeral 13, is provided.

In FIG. 4, the dummy last 7 is replaced with a last 13, and the figure also illustrates the step of injecting and forming the polyurethane mid-sole 14.

As clearly shown, the preparation of the vulcanized rubber sole and the subsequent operation for mating with the polyurethane mid-sole occur in the same machine and with an operating cycle in which the two steps occur one after the other.

As regards the reasons for the mating between the vulcanized rubber and polyurethane, they arise from the use of a mixture that contains a hydroxyl acrylic resin.

This resin, at the end of vulcanization, on the part of the sole where the polyurethane will be deposited, retains many free bonds, which combine with the polyurethane, determining an intimate and tough coupling.

In order to allow the mixture to be usable in this process, it is necessary to use a nitrile rubber of the medium-high nitrile type and the environment in which vulcanization occurs must be acid.

It is also necessary to keep the lower part of the sole being vulcanized at a higher temperature than the upper part, and this is allowed by the particular structure of the mold and of its fixtures.

It is also important to leave the mold parts not perfectly closed, so as to form what is known as engineered flash.

This allows the optimum provision of the vulcanized rubber sole and of the polyurethane mid-sole.

From what has been described and illustrated, it is evident that the intended aim and objects have all been achieved, and that in particular a process has been devised which allows to provide a vulcanized rubber tread sole coupled to a polyurethane mid-sole with a succession of steps that can be performed with a single machine and sequentially.

Equivalent components and equivalent mold structures can of course be used starting from the same inventive concept.

The disclosures in Italian Patent Application No. PD2000A000295 from which this application claims priority are incorporated herein by reference.

1. A process for manufacturing a sole for shoes composed of a tread sole made of vulcanized rubber coupled to a polyurethane mid-sole, characterized in that:
a) for the vulcanizable rubber, a mixture is provided which is composed of:
a₁) a vulcanizable nitrile rubber (NBR);
a₂) at least one hydroxyl acrylic resin;
a₃) at least one hydrocarbon resin;
a₄) at least one reinforcing filler;
a₅) at least one vulcanization accelerator;
b) a dosed amount of said mixture is introduced in a first cavity of a mold, which is formed by a pseudocylindrical side wall within which a sole bottom piston can perform a translational motion and is closed in an upper region by a first replaceable dummy last;
c) the process waits for the duration of the vulcanization time, keeping the sole bottom piston at a temperature of 100-200 ° C. and the dummy last at a temperature of 100-200 ° C., allowing their adjustment independently of each other and so that the sole bottom temperature is never lower than the temperature of the dummy last;
d) the sole bottom, with the tread sole adhering thereto, is subjected to a translational motion, so as to generate a second cavity, and the dummy last is replaced with a second dummy last or with a last with a fitted upper, closing it with the rings;
e) a dosed quantity of two-component polyurethane is injected into said second cavity;
f) the process waits for the reaction time of the polyurethane, keeping the second dummy last or the rings at a temperature of 30-80 ° C.; the sole is extracted and allowed to rest for the stabilization time.

2. The process according to claim 1, characterized in that said nitrile rubber is of the medium-high nitrile type.

3. The process according to claims 1 and 2, characterized in that said nitrile rubber has a low Mooney value (low viscosity).

4. The process according to claim 2, characterized in that said nitrile rubber is a butadiene-acrylonitrile copolymer commonly known by the acronym NBR.

5. The process according to claim 1, characterized in that said hydroxyl acrylic resin is of the family of polyacrylic resins with an OH content of less than 2.

6. The process according to claim 5, characterized in that said hydroxyl acrylic resin is used in a solvent.

7. The process according to claim 5, characterized in that said hydroxyl acrylic resin is present in a percentage by weight between 4 and 6% of the total weight of the mixture.

8. The process according to claim 1, characterized in that said hydrocarbon resin is of the family of aliphatic resins of petrochemical origin.

9. The process according to claim 8, characterized in that said hydrocarbon resin is in the solid state.

10. The process according to claim 8, characterized in that said hydrocarbon resin is present in a percentage by weight between 3 and 5% of the total weight of the mixture.

11. The process according to claim 8, characterized in that said hydrocarbon resin is a combination of hydrocarbon chains of C₅ origin.

12. The process according to claim 1, characterized in that said reinforcing filler is of the siliceous type.

13. The process according to claim 12, characterized in that said reinforcing filler is precipitated amorphous silica.

14. The process according to claim 12, characterized in that said reinforcing filler is a mixture containing 85 to 90% SiO₂ and with a BET value of 150 to 200 m²/g.

15. The process according to claim 12, characterized in that said reinforcing filler is present in a percentage by weight between 20 and 25% of the total weight of the mixture.

16. The process according to claim 1, characterized in that said vulcanization accelerator is of the mercaptan class.

17. The process according to claim 16, characterized in that said accelerator is activated by an ultra-accelerator of the thiuram class.

18. The process according to claim 16, characterized in that said accelerators are present in a percentage by weight between 1 and 1.5% of the total weight of the mixture.

19. Means for performing the process according to claim 1, characterized in that they comprise a mold provided with a bottom constituted by the head of a piston which can perform a translational motion, said head having the shape and the impression of the vulcanized rubber tread sole to be obtained, a replaceable dummy last and means for the controlled heating of the mold and of the dummy last.

20. The means according to claim 19, characterized in that they provide heating plates interposed in contact with the lower and upper mold parts.

21. The means according to claim 19, characterized in that thermally insulating plates are provided between the dummy. last and the retention rings.

22. The means according to claim 19, characterized in that said movable piston is provided with heating means suitable to keep it at a temperature of 100-200° C.

23. The means according to claim 19, characterized in that said mold is closed by a first replaceable dummy last, which is provided with heating means suitable to keep it at a temperature between 100 and 200 ° C. during the vulcanization step.

24. The means according to claim 19, characterized in that the heating devices are independently adjustable.

25. The means according to claim 19, characterized in that said mold is closed by a second dummy last or by a last with an upper closed by rings.

26. The means according to claim 19, characterized in that said rings have conditioning means suitable to keep them at a temperature of 30-80 ° C., said means being constituted by thermally insulating plates.

27. Use of a vulcanizable rubber mixture to perform the process according to claim 1, characterized in that said rubber mixture is composed of:
a₁) a vulcanizable nitrile rubber (NBR);
a₂) at least one hydroxyl acrylic resin;
a₃) at least one hydrocarbon resin;
a₄) at least one reinforcing filler;
a₅) at least one vulcanization accelerator.

28. The use of a mixture according to claim 27, characterized in that the vulcanizable nitrile rubber (NBR) employed is of the medium-high nitrile type.

29. The use of a vulcanizable rubber mixture according to claim 27, characterized in that in said mixture at least one hydroxyl acrylic resin is provided.
